(19) United States
(12) Patent Application Publication
(10) Pub. No.: US 2010/0100291 A1
(43) Pub. Date: Apr. 22, 2010

(54) VEHICLE, AND CONTROL METHOD AND CONTROL APPARATUS FOR AN AUTOMATIC TRANSMISSION

(75) Inventors: Eiji Fukushiro, Nagoya-shi (JP); Koji Oshima, Nagoya-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 12/450,557

(22) PCT Filed: Mar. 28, 2008
(86) PCT No.: PCT/JP2008/056823

§ 371 Date: Sep. 30, 2009

(30) Foreign Application Priority Data
Apr. 6, 2007 (JP) 2007 100782

(51) Int. Cl. G06F 19/00; F16H 61/04

(52) U.S. Cl. 701/55

(57) ABSTRACT

An ECU executes a program including the steps of: if downshift from a fifth gear implemented when a brake and a clutch both engage to a second gear implemented when a clutch and a brake both engage is done, or downshift from a sixth gear implemented when the brake and the clutch both engage to a third gear implemented when the clutch and the brake both engage is done, disengaging a frictional engagement element other than the clutch, i.e., the brake or the brake; and decreasing an engagement pressure that is applied to the clutch to a reference value of target engagement pressure.

### TECHNICAL FIELD

The present invention relates to vehicles, and methods and apparatuses for controlling automatic transmissions, and particularly to technology applied to control engagement elements for implementing gears.

### BACKGROUND ART

Conventionally there has been known an automatic transmission changing a combination of clutches, brakes and other similar engagement elements that engage to another combination thereof to shift gears. Such an automatic transmission may be required to shift from a gear implemented by engaging any two of a plurality of engagement elements to a gear implemented by engaging other different two of the plurality of engagement elements.

Japanese Patent Laying-Open No. 2002-195401 discloses a shift control device for an automatic transmission that requires four engagement elements to operate to shift from a first gear to a second gear and the first gear is achieved when a first engagement element and a second engagement element both engage and the second gear is achieved when a third engagement element and a fourth engagement element both engage. The shift control device disclosed in the document includes a shift control unit controlling the state of the second engagement element in accordance with that of the first engagement element.

As described in the document, when the first gear is shifted to the second gear the shift control device considers the state of the first engagement element that is disengaged in controlling that of the second engagement element. This can prevent disengaging the two engagement elements from proceeding disorderly, and matching the disengagement of the first and second engagement elements to the progress of the engagement of the third and fourth engagement elements to be engaged can prevent engine racing and thus achieve smooth gear shift control.

However, if the state of one of the two engagement elements disengaged as a gear is shifted is controlled in accordance with that of the other engagement element, as done by the shift control device described in Japanese Patent Laying-open No. 2002-195401, the gear can be shifted with both engagement elements having engagement force. This delays disengaging the engagement elements implementing the gear having been implemented before shifting. This may result in a delay in shifting the gear.

### DISCLOSURE OF THE INVENTION

The present invention contemplates a vehicle, a control method for an automatic transmission, and a control apparatus for an automatic transmission, that allow a gear to be shifted fast.

The present invention in one aspect provides a vehicle including: an automatic transmission implementing a gear of a first gear ratio when a first engagement element and a second engagement element both engage, implementing a gear of a second gear ratio when the second engagement element and a third engagement element both engage, and implementing a gear of a third gear ratio when the third engagement element and a fourth engagement element both engage; and an operation unit determining whether shifting from the gear of the third gear ratio to the gear of the first gear ratio is to be done, and if shifting from the gear of the third gear ratio to the gear of the first gear ratio is determined to be done, controlling the fourth engagement element to disengage and the third engagement element to have engagement force before the first engagement element and the second engagement element engage.

According to this configuration, a gear of a first gear ratio is implemented when a first engagement element and a second engagement element both engage. A gear of a second gear ratio is implemented when the second engagement element and a third engagement element both engage. A gear of a third gear ratio is implemented when the third engagement element and a fourth engagement element both engage. If a decision is made that shifting from the gear of the third gear ratio to the gear of the first gear ratio is to be done, the fourth engagement element is controlled to disengage and the third engagement element is controlled to have engagement force before the first engagement element and the second engagement element engage. Thus one of the two engagement elements implementing a gear before shifting can be disengaged and only the other can have engagement force. By disengaging one engagement element, shifting the gear can be started fast. Thus, shifting the gear can be started faster than when the state of one of two engagement elements disengaged as the gear is shifted is controlled in accordance with that of the other. Thus the gear can be shifted fast.

Preferably the operation unit controls the second engagement element to engage when an input shaft of the automatic transmission attains a speed equal to a synchronous speed of the input shaft of the automatic transmission associated with the gear of the second gear ratio during shifting from the gear of the third gear ratio to the gear of the first gear ratio.

According to this configuration, the second engagement element is engaged when an input shaft of the automatic transmission attains a speed equal to a synchronous speed of the input shaft of the automatic transmission associated with the gear of the second gear ratio during shifting from the gear of the third gear ratio to the gear of the first gear ratio. Thus when the input shaft attains a speed equal to the synchronous speed of the input shaft associated with the gear of the second gear ratio can be matched to when an engagement element engaged when the gear of the second gear ratio is implemented has engagement force. This can reduce shock caused in shifting gears.

Still preferably, the operation unit controls the third engagement element to disengage and the first engagement element to engage after the second engagement element engages.

According to this configuration, after the second engagement element engages the third engagement element disengages and the first engagement element engages. Shifting to the gear of the first gear ratio can thus be completed.

Still preferably, the automatic transmission is provided with a rotating member having its rotation restricted by the engagement force of the third engagement element. The operation unit sets a target value for the engagement force of the third engagement element in accordance with inertia of the rotating member, and controls the fourth engagement element to disengage and the engagement force of the third engagement element to have the target value, as set, before the first engagement element and the second engagement element engage.

According to this configuration, the automatic transmission is provided with a rotating member having its rotation restricted by the engagement force of the third engagement element. A target value is set for the engagement force of the third engagement element in accordance with inertia of the rotating member. If shifting from the gear of the third gear ratio to the gear of the first gear ratio is to be done then before the first engagement element and the second engagement element engage the fourth engagement element disengages and the engagement force of the third engagement element is set to have the target value as set. This can reduce the third engagement element's engagement force for example to a minimal engagement force that can counter the rotating member's inertial force, i.e., a minimal engagement force that can restrict the rotating member's rotation. Thus the rotating member can be prevented from rotating at excessive speed while a gear is shifted, and when the third engagement element disengages it can disengage fast. As a result, the automatic transmission's input shaft, which is coupled with the rotating member, can be prevented from rotating at excessive speed, and such shock that can be caused when a gear is shifted can thus be reduced, and shifting a gear can proceed fast.

Still preferably, the operation unit controls the fourth engagement element to disengage and the engagement force of the third engagement element to have the target value, as set, before the first engagement element and the second engagement element engage, and the operation unit controls the engagement force of the third engagement element to be held at the target value, as set, until the second engagement element engages.

According to this configuration, if the gear of the third gear ratio is shifted to the gear of the first gear ratio, then before the first engagement element and the second engagement element engage the fourth engagement element is disengaged and the engagement force of the third engagement element is set to have the target value as set, and until the second engagement element engages the engagement force of the third engagement element is held at the target value as set. The third engagement element's engagement force decreased for example to a minimal engagement force that can restrict the rotating member's speed can be maintained until the second engagement element is engaged. This can reduce shock that can be caused when the second engagement element engages.

Still preferably, the rotating member receives a torque from the input shaft of the automatic transmission. The operation unit detects a rate at which the input shaft of the automatic transmission increases in speed, and the operation unit sets the target value for the engagement force of the third engagement element in accordance with the rate to set the target value for the engagement force of the third engagement element in accordance with inertia of the rotating member.

According to this configuration, a target value can be set for the third engagement element's engagement force in accordance with a rate at which the automatic transmission's input shaft transmitting a torque to the rotating member increases in speed. The target value can thus be set for the third engagement element's engagement force in accordance with the rotating member's inertia.

Still preferably, the operation unit sets the target value for the engagement force of the third engagement element to be larger as the rate is larger, to set the target value for the engagement force of the third engagement element in accordance with the inertia of the rotating member.

According to this configuration, when the automatic transmission's input shaft increases in speed at a large rate it can be said that the rotating member's inertial force is larger than when the input shaft increases in speed at a small rate. Accordingly, a larger target value is set for the third engagement element's engagement force. Thus for larger inertial force of the rotating member, the third engagement element's engagement force can be increased to be larger. This can prevent the rotating member's inertial force from being excessive while a gear is shifted.

### BRIEF DESCRIPTION OF THE DRAWINGS

FIG. 1 is a schematic view of a configuration of a power train of a vehicle.

FIG. 2 is a skeletal view of a planetary gear unit of an automatic transmission.

FIG. 3 represents an operation table of an automatic transmission.

FIG. 4 shows an oil hydraulic circuit in the automatic transmission.

FIG. 5 is a block diagram of a function of an ECU.

FIG. 6 is timing plots representing oil pressure indicted for a frictional engagement element or the like.

FIG. 7 is a map used to calculate an amount of torque to be decreased.

FIG. 8 is timing plots representing a torque output from an engine and the like.

FIG. 9 is a (first) flowchart showing a structure of a program executed by the ECU for control.

FIG. 10 is a (second) flowchart showing a structure of a program executed by the ECU for control.

### BEST MODES FOR CARRYING OUT THE INVENTION

An embodiment of the present invention will be described hereinafter with reference to the drawings. In the following description, identical elements are denoted by identical reference characters. Their names and functions are also identical. Accordingly, they will not be described repeatedly in detail.

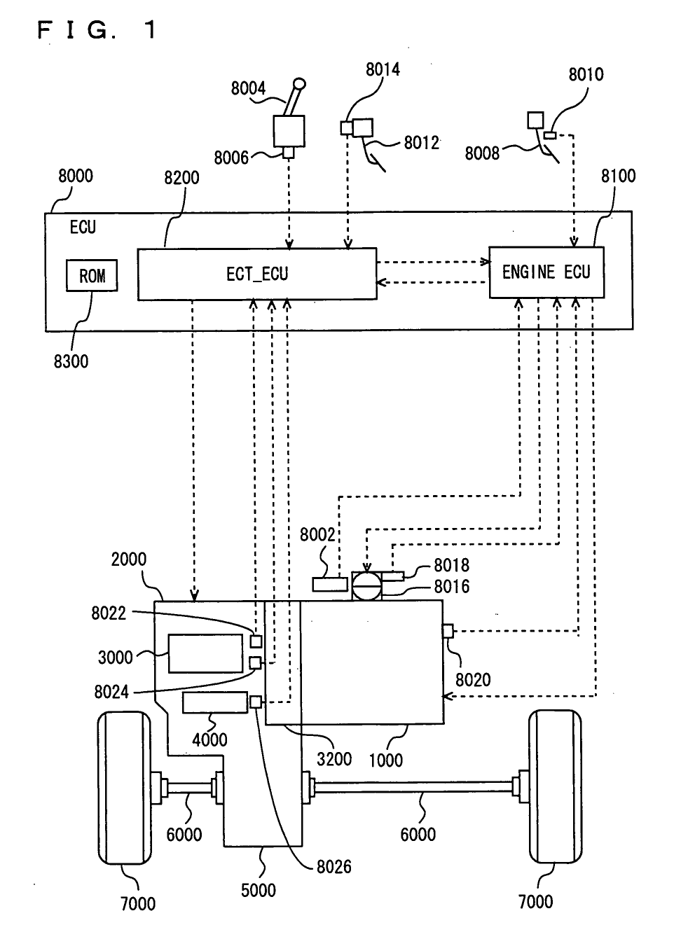

A vehicle incorporating a control apparatus according to an embodiment of the present invention will be described with reference to FIG. 1. The vehicle is an FF (front engine front drive) vehicle. It is not limited to the FF vehicle.

The vehicle includes an engine 1000, an automatic transmission 2000, a planetary gear unit 3000 constituting a portion of automatic transmission 2000, an oil hydraulic circuit 4000 constituting a portion of automatic transmission 2000, a differential gear 5000, a drive shaft 6000, a front wheel 7000, and an ECU (electronic control unit) 8000. In the present embodiment the control apparatus is implemented for example by executing a program recorded in a ROM (Read Only Memory) 8300 of ECU 8000. The program executed by ECU 8000 may be recorded in a CD (Compact Disc), a DVD (Digital Versatile Disc) or a similar storage medium and thus distributed in the market.

Engine 1000 is an internal combustion engine that burns a mixture of fuel injected from an injector (not shown) and air inside a combustion chamber of a cylinder. A piston in the cylinder is pushed down by the combustion, whereby a crankshaft is rotated. In addition to engine 1000, a motor may be used as a source of motive force.

Automatic transmission 2000 is coupled via a torque converter 3200 to engine 1000. Automatic transmission 2000 converts the revolution speed of the crankshaft to a desired revolution speed for speed change by implementing a desired gear.

The output gear of automatic transmission 2000 meshes with a differential gear 5000. A driveshaft 6000 is coupled to differential gear 5000 by spline-fitting for example. Motive force is transmitted to the left and right front wheels 7000 via driveshaft 6000.

An air flow meter 8002, a position switch 8006 of a shift lever 8004, an accelerator pedal position sensor 8010 of an accelerator pedal 8008, a force sensor 8014 for a brake pedal 8012, a throttle angle sensor 8018 for an electronic throttle valve 8016, and engine speed sensor 8020, an input shaft speed sensor 8022, an output shaft speed sensor 8024, and an oil temperature sensor 8026 are connected to ECU 8000 via a harness and the like.

Air flow meter 8002 detects an amount of air taken into engine 1000 and transmits a signal representing the detected result to ECU 8000. The position of shift lever 8004 is detected by position switch 8006, and a signal representing the detected result is transmitted to ECU 8000. A gear of automatic transmission 2000 is automatically implemented corresponding to the position of shift lever 8004. Additionally, the driver may operate to select a manual shift mode in which the driver can select a gear arbitrarily.

Accelerator pedal position sensor 8010 detects the position of accelerator pedal 8008, and transmits a signal representing the detected result to ECU 8000. Force sensor 8014 detects the force (exerted by the driver) to depress brake pedal 8012 and transmits a signal representing the detected result to ECU 8000.

Throttle angle sensor 8018 detects the angle of electronic throttle valve 8016 having its angle adjusted by an actuator, and transmits a signal representing the detected result to ECU 8000. Electronic throttle valve 8016 adjusts an amount of intake air taken into engine 1000 (i.e., an output of engine 1000).

Not that electronic throttle valve 8016 may be replaced with or employed together with intake and exhaust valves (not shown) lifted in a varying amount or opened/closed in a varying phase to adjust an amount of intake air taken into engine 1000.

Engine speed sensor 8020 detects the speed of an output shaft (crankshaft) of engine 1000 and transmits a signal representing the detected result to ECU 8000. Input shaft speed sensor 8022 detects an input shaft speed NI of automatic transmission 2000, or a turbine speed NT of torque converter 3200, and transmits a signal representing the detected result to ECU 8000. Output shaft speed sensor 8024 detects an output shaft speed NO of automatic transmission 2000, and transmits a signal representing the detected result to ECU 8000. From output shaft speed NO, vehicular speed is calculated (or detected).

Oil temperature sensor 8026 detects oil temperature, i.e., the temperature of an oil used in operating and lubricating automatic transmission 2000 (i.e., ATF: Automatic Transmission Fluid), and transmits a signal representing the detected result to ECU 8000.

ECU 8000 controls various devices such that the vehicle attains a desired traveling state based on signals transmitted from air flow meter 8002, position switch 8006, accelerator pedal position sensor 8010, force sensor 8014, throttle angle, sensor 8018, engine speed sensor 8020, input shaft speed sensor 8022, output shaft speed sensor 8024, oil temperature sensor 8026 and the like, as well as a map and a program stored in ROM 8300.

In the present embodiment when shift lever 8004 assumes a D (drive) position and thus a D (drive) range is selected as a shift range of automatic transmission 2000, ECU 8000 controls automatic transmission 2000 to implement any of first to sixth gears. As any of the first to sixth gears is implemented, automatic transmission 2000 can transmit driving force to front wheel 7000. Note that in the D range, a gear higher than the sixth gear, i.e., a seventh gear or an eighth gear may be implemented. A gear to be implemented is determined according to a gear shift map previously produced through an experiment or the like with vehicular speed and an accelerator pedal position serving as parameters.

As shown in FIG. 1, ECU 8000 includes an engine ECU 8100 controlling engine 1000, and an ECT (Electronic Controlled Transmission)_ECU 8200 controlling automatic transmission 2000.

Engine ECU 8100 and ECT_ECU 8200 are configured to be capable of mutually communicating signals. In the present embodiment, engine ECU 8100 transmits to ECT_ECU 8200 a signal representing an accelerator pedal position, a signal representing an output torque TEKL as converted from an amount of intake air, and the like. ECT_ECU 8200 transmits to engine ECU 8100 signals representing an amount of torque required that is determined as a torque that engine 1000 should output, an amount of torque to be decreased, an amount of torque to be increased, and the like.

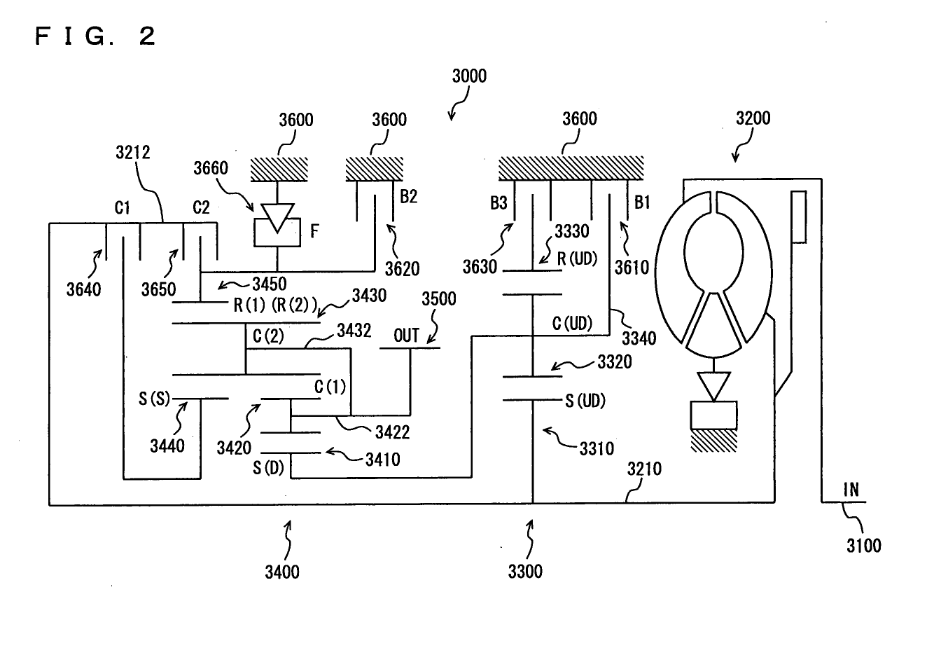

Planetary gear unit 3000 will be described with reference to FIG. 2. Planetary gear unit 3000 is connected to torque converter 3200 having an input shaft 3100 coupled to the crankshaft. Planetary gear unit 3000 includes a first set of the planetary gear mechanism 3300, a second set of the planetary gear mechanism 3400, an output gear 3500, B1, B2, and B3 brakes 3610, 3620 and 3630 fixed to a gear case 3600, C1 and C2 clutches 3640 and 3650, and a one-way clutch F 3660.

First set 3300 is a single pinion type planetary gear mechanism. First set 3300 includes a sun gear S (UD) 3310, a pinion gear 3320, a ring gear R (UD) 3330, and a carrier C (UD) 3340.

Sun gear S (UD) 3310 is coupled to an output shaft 3210 of torque converter 3200. Pinion gear 3320 is rotatably supported on carrier C (UD) 3340. Pinion gear 3320 engages with sun gear S (UD) 3310 and ring gear R (UD) 3300.

Ring gear R (UD) 3330 is fixed to gear case 3600 by B3 brake 3630. Carrier C (UD) 3340 is fixed to gear case 3600 by B1 brake 3610.

Second set 3400 is a Ravigneaux type planetary gear mechanism. Second set 3400 includes a sun gear S (D) 3410, a short pinion gear 3420, a carrier C (1) 3422, a long pinion gear 3430, a carrier C (2) 3432, a sun gear S (S) 3440, and a ring gear R (1) (R (2)) 3450.

Sun gear S (D) 3410 is coupled to carrier C (UD) 3340. Short pinion gear 3420 is rotatably supported on carrier C (1) 3422. Short pinion gear 3420 engages with sun gear S (D) 3410 and long pinion gear 3430. Carrier C (1) 3422 is coupled with output gear 3500.

Long pinion gear 3430 is rotatably supported on carrier C (2) 3432. Long pinion gear 3430 engages with short pinion gear 3420, sun gear S (S) 3440, and ring gear R (1) (R (2)) 3450. Carrier C (2) 3432 is coupled with output gear 3500.

Sun gear S (S) 3440 is coupled to output shaft 3210 of torque converter 3200 by C1 clutch 3640. Ring gear R (1) (R (2)) 3450 is fixed to gear case 3600 by B2 brake 3620, and coupled to output shaft 3210 of torque converter 3200 by C2 clutch 3650. Ring gear R (1) (R (2)) 3450 is coupled to one-way clutch F 3660, and is disabled in rotation during the drive in first gear.

When C2 clutch 3650 engages, a rotating member 3212 coupled with the input shaft of automatic transmission 2000, i.e., output shaft 3210 of torque converter 3200, and ring gear R(1) (R(2)) 3450 have their respective rotations restricted. Furthermore, rotating member 3212 has its rotation restricted by C1 clutch 3640 engaging. Rotating member 3212 receives torque from the input shaft of automatic transmission 2000.

One-way clutch F 3660 is provided in parallel with B2 brake 3620. Specifically, one-way clutch F 3660 has the outer race fixed to gear case 3600, and the inner race coupled to ring gear R (1) (R (2)) 3450 via the rotation shaft.

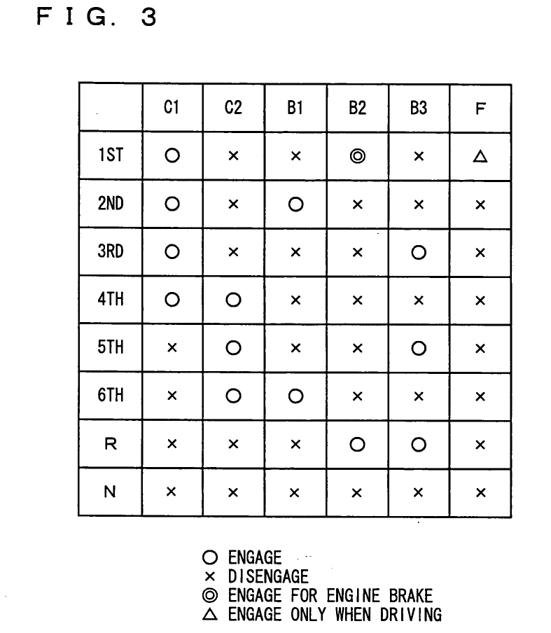

FIG. 3 is an operation table representing the relation between gears to be shifted and operation states of the clutches and brakes. By operating each brake and each clutch based on the combinations shown in the operation table, the forward gears including first gear to sixth gear and the reverse gear are implemented.

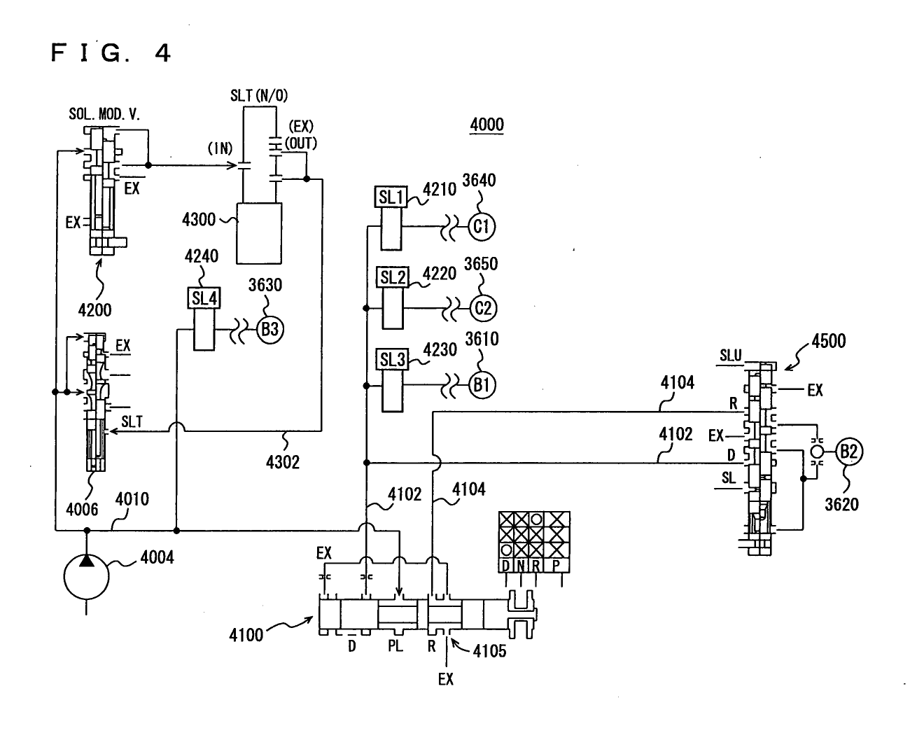

A main portion of oil hydraulic circuit 4000 will be described hereinafter with reference to FIG. 4. Note that oil hydraulic circuit 4000 is not limited to that described below.

Oil hydraulic circuit 4000 includes an oil pump 4004, a primary regulator valve 4006, a manual valve 4100, a solenoid modulator valve 4200, an SL1 linear solenoid (hereinafter indicated as SL (1)) 4210, an SL2 linear solenoid (hereinafter indicated as SL (2)) 4220, an SL3 linear solenoid (hereinafter indicated as SL (3)) 4230, an SL4 linear solenoid (hereinafter indicated as SL (4)) 4240, an SLT linear solenoid (hereinafter indicated as SLT) 4300, and a B2 control valve 4500.

Oil pump 4004 is coupled with the crankshaft of engine 1000. As the crankshaft rotates, oil pump 4004 is driven to generate oil pressure. The oil pressure generated at oil pump 4004 is adjusted by primary regulator valve 4006, whereby line pressure is generated.

Primary regulator valve 4006 operates with the throttle pressure adjusted by SLT 4300 as the pilot pressure. The line pressure is supplied to manual valve 4100 via a line pressure oil channel 4010.

Manual valve 4100 includes a drain port 4105. The oil pressure of a D range pressure oil channel 4102 and an R range pressure oil channel 4104 is discharged from drain port 4105. When the spool of manual valve 4100 is at the D position, line pressure oil channel 4010 communicates with D range pressure oil channel 4102, whereby oil pressure is supplied to D range pressure oil channel 4102. At this stage, R range pressure oil channel 4104 communicates with drain port 4105, whereby the R range pressure of R range pressure oil channel 4104 is discharged from drain port 4105.

When the spool of manual valve 4100 is at the R position, line pressure oil channel 4010 communicates with R range pressure oil channel 4104, whereby oil pressure is supplied to R range pressure oil channel 4104. At this stage, D range pressure oil channel 4102 communicates with drain port 4105, whereby the D range pressure of D range pressure oil channel 4102 is discharged from drain port 4105.

When the spool of manual valve 4100 is at the N position, D range pressure oil channel 4102 and R range pressure oil channel 4104 both communicate with drain port 4105, whereby the D range pressure of D range pressure oil channel 4102 and the R range pressure of R range pressure oil channel 4104 are discharged from drain port 4105.

The oil pressure supplied to D range pressure oil channel 4102 is eventually supplied to B1 brake 3610, B2 brake 3620, C1 clutch 3640 and C2 clutch 3650. The oil pressure supplied to R range pressure oil channel 4104 is eventually supplied to B2 brake 3620.

Solenoid modulator valve 4200 uses the line pressure as an original pressure and thus adjusts an oil pressure that is supplied to SLT 4300 (i.e., a solenoid modulator pressure) to be a prescribed pressure.

SL (1) 4210 adjusts the oil pressure supplied to C1 clutch 3640. SL (2) 4220 adjusts the oil pressure supplied to C2 clutch 3650. SL (3) 4230 adjusts the oil pressure supplied to B1 brake 3610. SL (4) 4240 adjusts the oil pressure supplied to B3 brake 3630.

SLT 4300 responds to a control signal issued from ECU 8000 as based on the accelerator pedal position detected by accelerator pedal position sensor 8010 to adjust the solenoid modulator pressure and generate the throttle pressure. The throttle pressure is supplied to primary regulator valve 4006 via SLT oil channel 4302. The throttle pressure is used as the pilot pressure of primary regulator valve 4006.

SL (1) 4210, SL (2) 4220, SL (3) 4230, SL (4) 4240 and SLT 4300 are controlled by a control signal transmitted from ECU 8000.

B2 control valve 4500 selectively supplies the oil pressure from one of D range pressure oil channel 4102 and R range pressure oil channel 4104 to B2 brake 3620. D range oil pressure 4102 and R range oil pressure 4104 are connected to B2 control valve 4500. B2 control valve 4500 is controlled by the oil pressure supplied from an SL solenoid valve (not shown) and an SLU solenoid valve (not shown) and the urge of the spring.

When the SL solenoid valve is OFF and the SLU solenoid valve is ON, B2 control valve 4500 attains the left side state of FIG. 4. In this case, B2 brake 3620 is supplied with oil pressure having the D range pressure adjusted with the oil pressure supplied from the SLU solenoid valve as the pilot pressure.

When the SL solenoid valve is ON and the SLU solenoid valve is OFF, B2 control valve 4500 attains the right side state of FIG. 4. In this case, B2 brake 3620 is supplied with the R range pressure.

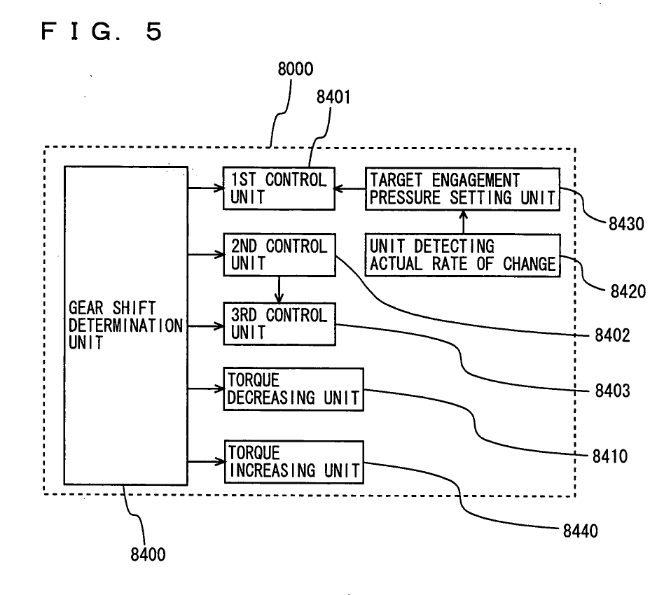

With reference to FIG. 5, ECU 8000 has a function, as will be described hereinafter. Note that the function of ECU 8000 described below may be implemented by hardware or software.

ECU 8000 includes a gear shift determination unit 8400, a first control unit 8401, a second control unit 8402, a third control unit 8403, a torque decreasing unit 8410, a unit 8420 detecting an actual rate of change, a target engagement pressure setting unit 8430, and a torque increasing unit 8440.

A gear shift determination unit 8400 determines whether downshifting from the fifth gear to the second gear or from the sixth gear to the third gear to be done. This decision is made with reference for example to a gear shift map having vehicular speed and accelerator pedal position as parameters.

If downshifting from the fifth gear implemented when B3 brake 3630 and C2 clutch 3650 both engage to the second gear implemented when C1 clutch 3640 and B1 brake 3610 both engage is done, first control unit 8401 controls B3 brake 3630 to disengage and C2 clutch 3650 to have engagement force before C1 clutch 3640 and B1 brake 3610 engage.

Furthermore if downshifting from the sixth gear implemented when B1 brake 3610 and C2 clutch 3650 both engage to the third gear implemented when C1 clutch 3640 and B3 brake 3630 both engage is done, first control unit 8401 controls B1 brake 3610 to disengage and C2 clutch 3650 to have engagement force before C1 clutch 3640 and B3 brake 3630 engage.

The engagement force is controlled by changing a frictional engagement element's engagement pressure, i.e., oil pressure supplied to the frictional engagement element. C2 clutch 3650 receives an engagement pressure reduced to be equal to a target engagement pressure set by target engagement pressure setting unit 8430 in a method described later.

If downshifting from the fifth gear to the second gear or from the sixth gear to the third gear is done, when a period of time T(1) elapses after the downshift starts second control unit 8402 engages C1 clutch 3640.

C1 clutch 3640 is timed to engage when torque converter 3200 attains turbine speed NT, i.e., automatic transmission 2000 attains input shaft speed NI, that is equal to a synchronous speed calculated by multiplying output shaft speed NO by a gear ratio of the fourth gear.

After C1 clutch 3640 is engaged, third control unit 8403 disengages C2 clutch 3650 and engages B1 brake 3610 or B3 brake 3630. More specifically, after C1 clutch 3640 is engaged once a period of time T(2) has elapsed, C2 clutch 3650 receives engagement pressure gradually decreased at a predetermined rate. Finally, C2 clutch 3650 is disengaged.

Subsequently, the control operates to allow B1 brake 3610 or B3 brake 3630 to start to have engagement force, when turbine speed NT of torque converter 3200, i.e., input shaft speed NI of automatic transmission 2000 synchronizes with a synchronous speed calculated by multiplying output shaft speed NO by a gear ratio of a gear that is implemented as a gear is shifted thereto. Finally, B1 brake 3610 or B3 brake 3630 is engaged. If downshifting from the fifth gear to the second gear is done, B1 brake 3610 is engaged. If downshifting from the sixth gear to the third gear is done, B3 brake 3630 is engaged.

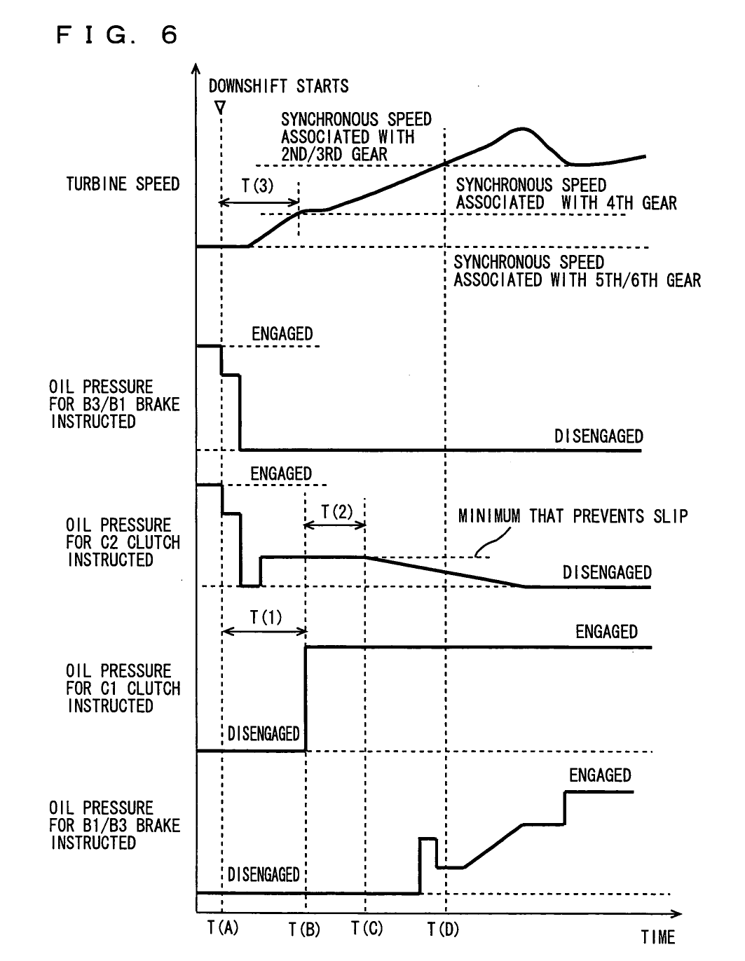

Reference will now be made to FIG. 6 to describe a manner of controlling each frictional engagement element when downshifting from the fifth gear to the second gear is done.

At time T(A), downshifting the gear is started, and subsequently, B3 brake 3630 is disengaged. C2 clutch 3650 receives an engagement pressure decreased to the target engagement pressure. After downshifting the gear is started when a period of time T(1) elapses and time T(B) arrives, C1 clutch 3640 is engaged. Subsequently, when a period of time T(2) elapses and time T(C) arrives, C2 clutch 3650 receives an engagement pressure gradually decreased at a predetermined rate.

Subsequently, the control operates to allow B1 brake 3610 to start to have engagement force at time T(D), when turbine speed NT of torque converter 3200, i.e., input shaft speed NI of automatic transmission 2000 synchronizes with a synchronous speed calculated by multiplying output shaft speed NO by a gear ratio of a gear that is implemented as a gear is shifted thereto.

Downshifting from the sixth gear to the third gear is done similarly to downshifting from the fifth gear to the second gear. In other words, downshifting from the sixth gear to the third gear is done in a manner similar to downshifting from the fifth gear to the second gear, except that B1 brake 3610 is replaced with B3 brake 3630, and the like.

After downshifting from the fifth/sixth gear to the second/third gear, respectively, is started, torque decreasing unit 8410 introduces a spark retard to reduce a torque output from engine 1000 to allow turbine speed NT to increase to the synchronous speed that is associated with the fourth gear for a period of time T(3), as shown in FIG. 6.

The period of time T(3) is set to be equal to or substantially equal to the period of time T(1). Thus C1 clutch 3640 can be timed to engage when turbine speed NT of torque converter 3200 attains the same speed as the synchronous speed associated with the gear ratio of the fourth gear.

The output torque is decreased by an amount of torque to be decreased, which is calculated as based on output torque TEKL from engine 1000 as converted from an amount of intake air detected by air flow meter 8002, and output shaft speed NO of automatic transmission 2000. For example, a output torque from engine 1000 is converted from an amount of intake air for example with reference to a map with the amount of intake air and engine speed NE serving as parameters. The output torque from engine 1000 can be converted from the amount of intake air by well known general methods. Accordingly, further description will not be provided.

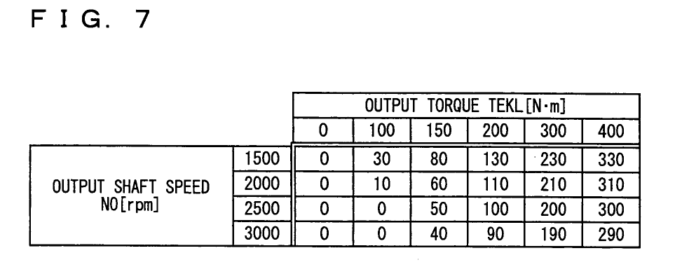

As shown in FIG. 7, an amount of torque to be decreased is set with reference to a map having output torque TEKL as converted from an amount of intake air and output shaft speed NO of automatic transmission 2000 serving as parameters.

In principle, for a single output shaft speed NO, amounts of torque to be decreased are set so that output torques TEKLs, as converted from amounts of intake air, minus their respective amounts to be decreased have equal values.

Engine 1000 is controlled to output a torque that is output torque TEKL, as converted from an amount of intake air, minus an amount of torque to be decreased, as set. In other words, engine 1000 outputs a torque decreased to a fixed torque determined for each output shaft speed NO. After a torque output is decreased when turbine speed NT increases and attains the synchronous speed associated with the fourth gear, the torque output from engine 1000 increases.

Unit 8420 detecting an actual rate of change detects an actual rate of change of turbine speed NT (input shaft speed NI) detected by input shaft speed sensor 8022 after downshifting from the fifth/sixth gear to the second/third gear, respectively, is started.

Target engagement pressure setting unit 8430 sets a target engagement pressure for C2 clutch 3650 in accordance with inertia of rotating member 3212 by setting the target engagement pressure for C2 clutch 3650 to increase for larger rates of change ΔNT of turbine speed NT provided after an inertia phase begins.

More specifically, the target engagement pressure is set as a sum of a reference value and a correction value. The reference value is predetermined through an experiment or by simulation. The correction value is set in accordance with a map having the rate of change ΔNT of turbine speed NT as a parameter. Setting the correction value in accordance with the rate of change ΔNT sets the target engagement pressure in accordance with the rate of change ΔNT. The target engagement pressure is set between an upper limit value and a lower limit value.

Furthermore, the target engagement pressure is set to allow C2 clutch 3650 to have a minimal engagement force that can restrict the rotation of rotating member 3212. More specifically, the target engagement pressure is set to allow C2 clutch 3650 to have a minimal engagement force required to prevent C2 clutch 3650 from slipping.

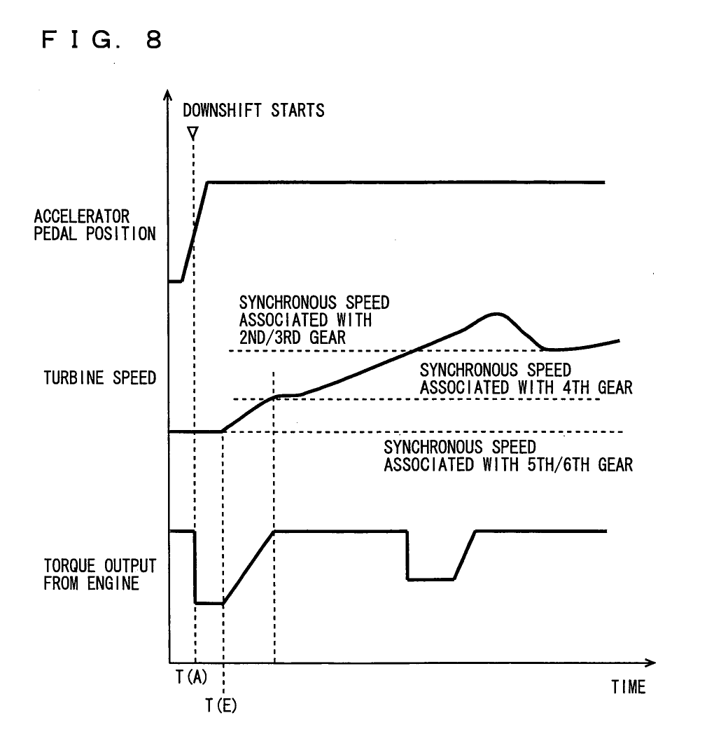

As shown in FIG. 8, engine 1000 outputs a decreased torque and thereafter when time T(E) arrives, or an inertia phase begins, torque increasing unit 8440 exerts control to increase gradually at a predetermined rate the torque output from engine 100.

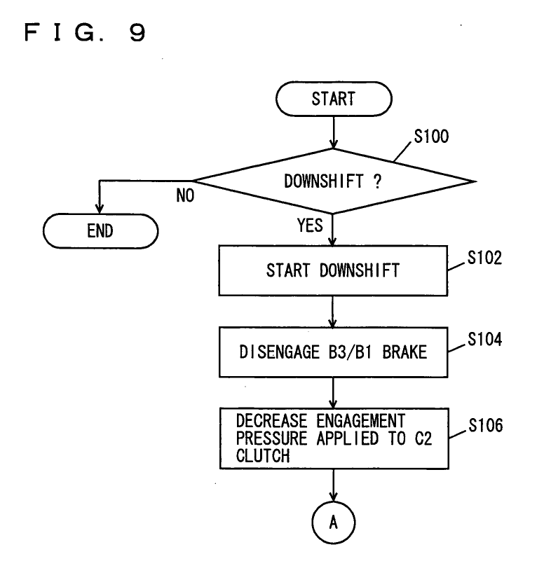

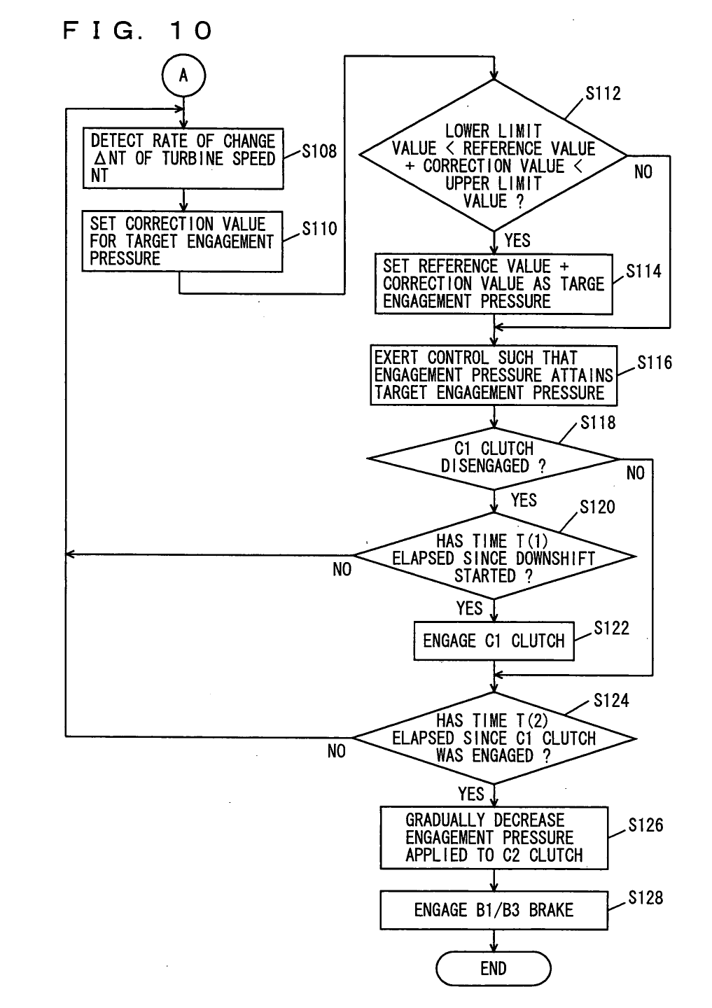

Reference will now be made to FIG. 9 and FIG. 10 to describe a structure of a program executed by the control apparatus of the present embodiment, or ECU 8000, for control. Note that the program described below is repeated periodically as predetermined.

At step (S)100, ECU 8000 determines whether downshifting from the fifth gear to the second gear or from the sixth gear to the third gear to be done. If so (YES at S100), the process proceeds to S102. Otherwise (NO at S100), the process ends.

At S102, ECU 8000 starts downshifting from the fifth gear to the second gear or from the sixth gear to the third gear.

At S104, ECU 8000 disengages a frictional engagement element other than C2 clutch 3650, i.e., B3 brake 3630 or B1 brake 3610. If downshifting from the fifth gear to the second gear is done, B3 brake 3630 is disengaged. If downshifting from the sixth gear to the third gear is done, B1 brake 3610 is disengaged.

At S106, ECU 8000 decreases the engagement pressure that is applied to C2 clutch 3650 to the reference value of target engagement pressure described above. In other words, the reference value is set as the target engagement pressure.

At S108, ECU 8000 detects a rate of change ΔNT of turbine speed NT (input shaft speed NI) detected by input shaft speed sensor 8022.

At S110, ECU 8000 sets a correction value for the target engagement pressure, as based on the rate of change ΔNT of turbine speed NT.

At S112, ECU 8000 determines whether the reference value of the target engagement pressure plus the correction value is larger than the lower limit value and smaller than the upper limit value. If so (YES at S112), the process proceeds to S114. Otherwise (NO at S112), the process proceeds to S116.

At S114, ECU 8000 sets the reference value of the target engagement pressure plus the correction value as a target engagement pressure. At S116, ECU 8000 exerts control such that the engagement pressure applied to C2 clutch 3650 attains the target engagement pressure.

At S118, ECU 8000 determines whether C1 clutch 3640 is disengaged. If so (YES at S118), the process proceeds to S120. Otherwise (NO at S118), the process proceeds to S124.

At S120, ECU 8000 determines whether the period of time T(1) has elapsed since the downshift started. If so (YES at S120), the process proceeds to S122. Otherwise (NO at S120), the process returns to S108. At S122, ECU 8000 engages C1 clutch 3640.

At S124, ECU 8000 determines whether the period of time T(2) has elapsed since C1 clutch 3640 was engaged. If so (YES at S124), the process proceeds to S126. Otherwise (NO at S124), the process returns to S108. At S126, ECU 8000 gradually decreases at a predetermined rate the engagement pressure applied to C2 clutch 3650.

At S128, ECU 8000 controls a frictional engagement element other than C1 clutch 3640, i.e., B1 brake 3610 or B3 brake 3630, to start to have engagement force when turbine speed NT, i.e., input shaft speed NI, synchronizes with a synchronous speed calculated by multiplying output shaft speed NO by a gear ratio of a gear that is implemented as a gear is shifted thereto. If downshifting from the fifth gear to the second gear is done, B1 brake 3610 is finally engaged. If downshifting from the sixth gear to the third gear is done, B3 brake 3630 is finally engaged.

In accordance with the structure and flowchart as described above, the control apparatus of the present embodiment, or ECU 8000, operates, as will be described hereinafter.

For example if a driver performs an operation for acceleration to provide a significantly increased accelerator pedal position, a decision is made that downshifting from the fifth gear to the second gear or from the sixth gear to the third gear to be done (YES at S100). Accordingly, downshifting from the fifth/sixth gear to the second/third gear, respectively, starts (S102).

In the following description, downshifting from the sixth gear to the third gear is done for the sake of illustration. When the downshift starts, a frictional engagement element other than C2 clutch 3650, i.e., B1 brake 3610 is disengaged (S104). C2 clutch 3650 receives an engagement pressure decreased to the reference value of target engagement pressure (S106).

Thus one of the two frictional engagement elements implementing a gear before shifting can be disengaged and only the other can have engagement force. By disengaging one frictional engagement element, shifting the gear can be started fast. Thus, shifting the gear can be started faster than when the state of one of two frictional engagement elements disengaged as the gear is shifted is controlled in accordance with that of the other.

Subsequently, the rate of change ΔNT of turbine speed NT detected by input shaft speed sensor 8022, is detected (S108), and in accordance with the rate of change ΔNT of turbine speed NT, a correction value is set for the target engagement pressure (S110).

If the reference value of the target engagement pressure plus the correction value is larger than the lower limit value and smaller than the upper limit value (YES at S112), the reference value plus the correction value is set as a target engagement pressure (S114). The control operates such that the engagement pressure applied to C2 clutch 3650 attains the newly set target engagement pressure (S116).

As described above, C2 clutch 3650 receives a target engagement pressure set to allow C2 clutch 3650 to have a minimal engagement force that can restrict the rotation of rotating member 3212. This can restrict rotating member 3212 from having excessive speed, i.e., the input shaft of automatic transmission 2000 from having excessive speed.

If C1 clutch 3640 is disengaged (YES at S118), then after the downshift started when the period of time T(1) elapses (YES at S120), C1 clutch 3640 is engaged (S122). C1 clutch 3640 is timed to engage when turbine speed NT of torque converter 3200 attains a speed equal to the synchronous speed associated with the gear ratio of the fourth gear. This can reduce shock that can be caused when C1 clutch 3640 is engaged.

After C1 clutch 3640 is engaged when the period of time T(2) elapses (YES at S124), C2 clutch 3650 receives an engagement pressure gradually decreased at a predetermined rate (S126).

As described above, C2 clutch 3650 receives a target engagement pressure set to allow C2 clutch 3650 to have a minimal engagement force that can restrict the rotation of rotating member 3212. This can prevent rotating member 3212 from rotating at excessive speed, i.e., the input shaft of automatic transmission 2000 from rotating at excessive speed, and also allows C2 clutch 3650 to be fast disengaged.

Furthermore, thereafter, B3 brake 3630 is controlled to start to have engagement force when turbine speed NT, i.e., input shaft speed NI, synchronizes with a synchronous speed calculated by multiplying output shaft speed NO by the gear ratio of the third gear (S128).

Thus if downshifting from a fifth gear implemented when a B3 brake and a C2 clutch both engage to a second gear implemented when a C1 clutch and a B1 brake both engage is done, the control apparatus of the present embodiment, or an ECU, controls the B3 brake to disengage and the C2 clutch to have engagement force before the C1 clutch and the B1 brake engage. If downshifting from a sixth gear implemented when the B1 brake and the C2 clutch both engage to a third gear implemented when the C1 clutch and the B3 brake both engage, the control apparatus of the present embodiment, or the ECU, controls the B1 brake to disengage and the C2 clutch to have engagement force before the C1 clutch and the B3 brake engage. Thus one of the two frictional engagement elements implementing a gear before shifting can be disengaged and only the other can have engagement force. By disengaging one frictional engagement element, shifting the gear can be started fast. Thus, shifting the gear can be started faster than when the state of one of two frictional engagement elements disengaged as the gear is shifted is controlled in accordance with that of the other. Thus the gear can be shifted fast.

Note that the present embodiment has been described in conjunction with downshifting from the fifth/sixth gear to the second/third gear, respectively, the present invention is not limited to shifting gears of such combinations.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

1. A vehicle comprising:
an automatic transmission implementing a gear of a first gear ratio when a first engagement element and a second engagement element both engage, implementing a gear of a second gear ratio when said second engagement element and a third engagement element both engage, and implementing a gear of a third gear ratio when said third engagement element and a fourth engagement element both engage; and
an operation unit determining whether shifting from said gear of said third gear ratio to said gear of said first gear ratio is to be done, and if shifting from said gear of said third gear ratio to said gear of said first gear ratio is determined to be done, controlling said fourth engagement element to disengage and said third engagement element to have engagement force before said first engagement element and said second engagement element engage.

2. The vehicle according to claim 1, wherein said operation unit controls said second engagement element to engage when an input shaft of said automatic transmission attains a speed equal to a synchronous speed of said input shaft of said automatic transmission associated with said gear of said second gear ratio during shifting from said gear of said third gear ratio to said gear of said first gear ratio.

3. The vehicle according to claim 2, wherein said operation unit controls said third engagement element to disengage and said first engagement element to engage after said second engagement element engages.

4. The vehicle according to claim 1, wherein:
said automatic transmission is provided with a rotating member having its rotation restricted by said engagement force of said third engagement element; and
said operation unit sets a target value for said engagement force of said third engagement element in accordance with inertia of said rotating member, and controls said fourth engagement element to disengage and said engagement force of said third engagement element to have said target value, as set, before said first engagement element and said second engagement element engage.

5. The vehicle according to claim 4, wherein said operation unit controls said fourth engagement element to disengage and said engagement force of said third engagement element to have said target value, as set, before said first engagement element and said second engagement element engage, and said operation unit controls said engagement force of said third engagement element to be held at said target value, as set, until said second engagement element engages.

6. The vehicle according to claim 4, wherein:
said rotating member receives a torque from an input shaft of said automatic transmission; and
said operation unit detects a rate at which said input shaft of said automatic transmission increases in speed, and said operation unit sets said target value for said engagement force of said third engagement element in accordance with said rate to set said target value for said engagement force of said third engagement element in accordance with inertia of said rotating member.

7. The vehicle according to claim 6, wherein said operation unit sets said target value for said engagement force of said third engagement element to be larger as said rate is larger, to set said target value for said engagement force of said third engagement element in accordance with the inertia of said rotating member.

8. A control method for an automatic transmission implementing a gear of a first gear ratio when a first engagement element and a second engagement element both engage, implementing a gear of a second gear ratio when said second engagement element and a third engagement element both engage, and implementing a gear of a third gear ratio when said third engagement element and a fourth engagement element both engage, the method comprising the steps of:
determining whether shifting from said gear of said third gear ratio to said gear of said first gear ratio is to be done; and
if shifting from said gear of said third gear ratio to said gear of said first gear ratio is determined to be done, controlling said fourth engagement element to disengage and said third engagement element to have engagement force before said first engagement element and said second engagement element engage.

9. The control method for an automatic transmission according to claim 8, further comprising the step of controlling said second engagement element to engage when an input shaft of said automatic transmission attains a speed equal to a synchronous speed of said input shaft of said automatic transmission associated with said gear of said second gear ratio during shifting from said gear of said third gear ratio to said gear of said first gear ratio.

10. The control method for an automatic transmission according to claim 9, further comprising the step of controlling said third engagement element to disengage and said first engagement element to engage after said second engagement element engages.

11. The control method for an automatic transmission according to claim 8, said automatic transmission being provided with a rotating member having its rotation restricted by said engagement force of said third engagement element, the method further comprising the step of setting a target value for said engagement force of said third engagement element in accordance with inertia of said rotating member, wherein the step of controlling said fourth engagement element to disengage and said third engagement element to have engagement force before said first engagement element and said second engagement element engage includes the step of controlling said fourth engagement element to disengage and said engagement force of said third engagement element to have said target value, as set, before said first engagement element, and said second engagement element engage.

12. The control method for an automatic transmission according to claim 11, wherein the step of controlling said fourth engagement element to disengage and said engagement force of said third engagement element to have said target value, as set, before said first engagement element and said second engagement element engage includes the step of controlling said fourth engagement element to disengage and said engagement force of said third engagement element to have said target value, as set, before said first engagement element and said second engagement element engage, and controlling said engagement force of said third engagement element to be held at said target value, as set, until said second engagement element engages.

13. The control method for an automatic transmission according to claim 11, said rotating member receiving a torque from an input shaft of said automatic transmission, the method further comprising the step of detecting a rate at which said input shaft of said automatic transmission increases in speed, wherein the step of setting said target value for said engagement force of said third engagement element includes the step of setting said target value for said engagement force of said third engagement element in accordance with said rate to set said target value for said engagement force of said third engagement element in accordance with inertia of said rotating member.

14. The control method for an automatic transmission according to claim 13, wherein the step of setting said target value for said engagement force of said third engagement element in accordance with said rate includes the step of setting said target value for said engagement force of said third engagement element to be larger as said rate is larger, to set said target value for said engagement force of said third engagement element in accordance with the inertia of said rotating member.

15. An control apparatus for an automatic transmission implementing a gear of a first gear ratio when a first engagement element and a second engagement element both engage, implementing a gear of a second gear ratio when said second engagement element and a third engagement element both engage, and implementing a gear of a third gear ratio when said third engagement element and a fourth engagement element both engage, comprising:
means for determining whether shifting from said gear of said third gear ratio to said gear of said first gear ratio is to be done; and
control means for controlling fourth engagement element to disengage and said third engagement element to have engagement force before said first engagement element and said second engagement element engage if shifting from said gear of said third gear ratio to said gear of said first gear ratio is determined to be done.

16. The control apparatus for an automatic transmission according to claim 15, further comprising means for controlling said second engagement element to engage when an input shaft of said automatic transmission attains a speed equal to a synchronous speed of said input shaft of said automatic transmission associated with said gear of said second gear ratio during shifting from said gear of said third gear ratio to said gear of said first gear ratio.

17. The control apparatus for an automatic transmission according to claim 16, further comprising means for controlling said third engagement element to disengage and said first engagement element to engage after said second engagement element engages.

18. The control apparatus for an automatic transmission according to claim 15, said automatic transmission being provided with a rotating member having its rotation restricted by said engagement force of said third engagement element, the apparatus further comprising means for setting a target value for said engagement force of said third engagement element in accordance with inertia of said rotating member, wherein said control means includes engagement force controlling means for controlling said fourth engagement element to disengage and said engagement force of said third engagement element to have said target value, as set, before said first engagement element and said second engagement element engage.

19. The control apparatus for an automatic transmission according to claim 18, wherein said engagement force controlling means includes means for controlling said fourth engagement element to disengage and said engagement force of said third engagement element to have said target value, as set, before said first engagement element and said second engagement element engage, and controlling said engagement force of said third engagement element to be held at said target value, as set, until said second engagement element engages.

20. The control apparatus for an automatic transmission according to claim 18, said rotating member receiving a torque from an input shaft of said automatic transmission, the apparatus further comprising means for detecting a rate at which said input shaft of said automatic transmission increases in speed, wherein said means for setting includes target setting means for setting said target value for said engagement force of said third engagement element in accordance with said rate to set said target value for said engagement force of said third engagement element in accordance with inertia of said rotating member.

21. The control apparatus for an automatic transmission according to claim 20, wherein said target setting means includes means for setting said target value for said engagement force of said third engagement element to be larger as said rate is larger, to set said target value for said engagement force of said third engagement element in accordance with the inertia of said rotating member.
